(19) United States
(12) Patent Application Publication
(10) Pub. No.: US 2002/0175498 A1
(43) Pub. Date: Nov. 28, 2002

(54) Connnecting device for auxiliary member of a baby carrier

(75) Inventors: Cheng-Fan Yang, Tainan Hsien (TW); Lung-Yin Lin, Nantou (TW); Kuang-Neng Cheng, Chia-I Hsien (TW)

Correspondence Address: BIRCH STEWART KOLASCH & BIRCH, PO BOX 747, FALLS CHURCH, VA, 22040-0747, US

(73) Assignee: LINK TREASURE LIMITED

(21) Appl. No.: 10/206,358

(22) Filed: Jul. 29, 2002

Related U.S. Application Data
(63) Continuation-in-part of application No. 09/689,605, filed on Oct. 13, 2000.

(51) Int. Cl. B62B 9/12; B62B 9/24

(52) U.S. Cl. 280/648; 280/47.38

(57) ABSTRACT

A connecting device for linking an auxiliary member, such as a tray or a front handrail, to a baby carrier. The connecting device is capable of making the auxiliary member pivotally movable between a usage position across the first and second side arm and a storage position in front of one of the side arm of the baby carrier. It reduces possibilities of nipping or injury to the occupant's fingers.

### BACKGROUND OF THE INVENTION

1. Field of Invention

The invention relates in general to a connecting device for linking an auxiliary member, such as a tray or a front handrail, to a baby carrier, such as a stroller, a highchair or a swing, and more particularly relates to a connecting device that is capable of making the auxiliary member pivotally movable relative to the baby carrier and totally removed from the baby carrier.

2. Related Art

In a baby carrier, such as a stroller, a highchair or a swing, there is generally a need to have a tray or a front handrail located in front of the carrier for providing toys or food for the baby, or guarding the baby in place.

For instance, an earlier design of a tray for a highchair is a movable tray pivotally mounted on the back of the highchair. The tray rotates forward to place on handrails of the highchair for using, and rotates backward to lean on the back when it is not in use. Since rotating the tray to the handrail is a clamp motion, it is easy to injure the baby if it is not carefully observed.

In order to improve the tray structure for baby seats, there have been lots of designs developed. For example, in U.S. Pat. No. 5,507,550, a highchair including a mechanism for adjusting position of the tray makes the structure more complicated. While, in U.S. Pat. No. 5,586,800, a highchair having a tray directly mounted on the seat makes the structure simpler.

Whatever the tray mechanisms are applied to strollers or highchairs, simple or complicated, the trays are removably mounted on the seat, i.e., installed to the strollers or highchairs for the baby to have meal, and removed after using. When the tray is mounted on the seat, it has to be removed or moved away before seating the baby, and restored afterwards. And, when the baby is to be lifted from the seat, the tray has to be removed again. The repeated mounting and removal are rather bothersome and inconvenient. If the tray is a separated piece, leaving it on the seat will occupy more storage space, but removing it would lose a suitable placement.

There are applied some patents to improve these disadvantages. As U.S. Pat. No. 3,575,466, it discloses a chair construction that is movable between a storage position and a position for normal use. In the storage position, the table member is aside the chair. And as U.S. Pat. No. 4,685,726, it discloses a chair with a movable tray. The tray is securely stored at side of the chair. Both they provide adjustable and movable structure to the table member or tray. But in the storage position, the table member or tray is located aside the chair. It must nip occupant's fingers and be injury, especially for the infants and elderly.

### SUMMARY OF THE INVENTION

A primary object of the invention is therefore to provide a connecting device for linking an auxiliary member, such as a tray or a front handrail, to a baby carrier. The connecting device is capable of making the auxiliary member pivotally movable between a usage position and a storage position in front of the baby carrier. And the auxiliary member is totally removed from the baby carrier.

To achieve the aforesaid object, a connecting device for linking an auxiliary member to a baby carrier includes a pivotal mechanism and a latch mechanism. The pivotal mechanism includes a cylinder mounted one of the auxiliary member and the end of first side arm of the baby carrier, and a recess fixed on the other of the auxiliary member and the end of first side arm of the baby carrier. The recess receives the cylinder to make the auxiliary member attach to the first side arm and rotate relative to the baby carrier in the longitudinal direction of the cylinder. And the latch mechanism selectively locks or unlocks the auxiliary member to the second side arm of the baby carrier.

When the latch mechanism locks, the auxiliary member is across the first and second side arm of the baby carrier in a horizontal usage position. And when the latch mechanism unlocks, the auxiliary member rotates relative to the baby carrier in the longitudinal direction of the cylinder. The auxiliary member reaches to a vertical storage position in front of the first arm. It reduces possibilities of nipping or injury to the occupant's fingers.

The cylinder further comprises a head portion and an adjacent neck portion. The recess has a pin to be against the neck portion and block the head portion to prevent the cylinder detaching from the recess when the auxiliary member rotates relative to the baby carrier. The auxiliary member can totally remove from the baby carrier when the pin releases the head portion.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1A is a perspective view of the connecting device in the usage position of the invention;

FIG. 1B is a perspective view of the connecting device in the storage position of the invention;

FIG. 2 is a perspective view of a pivotal mechanism in a connecting device according to the invention;

FIG. 3 is a sectional view of a pivotal mechanism in the invention in a fixed condition;

FIG. 4A is sectional view of first embodiment of the hook in the invention;

FIG. 4B is sectional view of second embodiment of the hook in the invention;

FIG. 5 is a sectional view of a connecting device of the invention in a usage position;

FIG. 6 is a sectional view of a connecting device of the invention in a storage position;

FIG. 7 is a perspective view of the second embodiment of the pivotal mechanism;

FIGS. 8A, 8B are cross-sectional view of the FIG. 7 in rotating; and

FIG. 9 is a perspective view of the second embodiment of the latch mechanism.

### DETAILED DESCRIPTION OF THE INVENTION

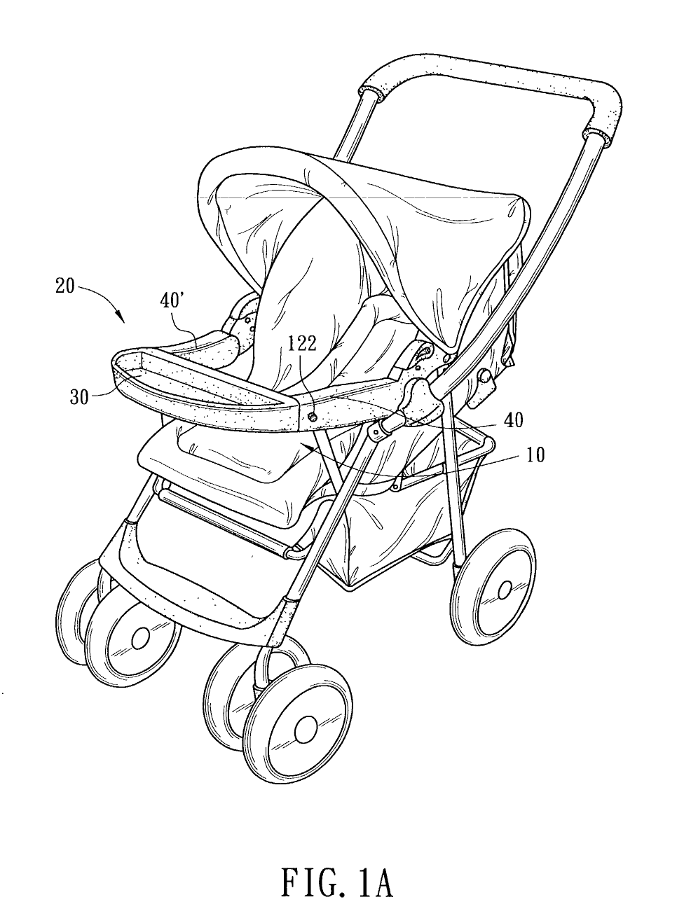

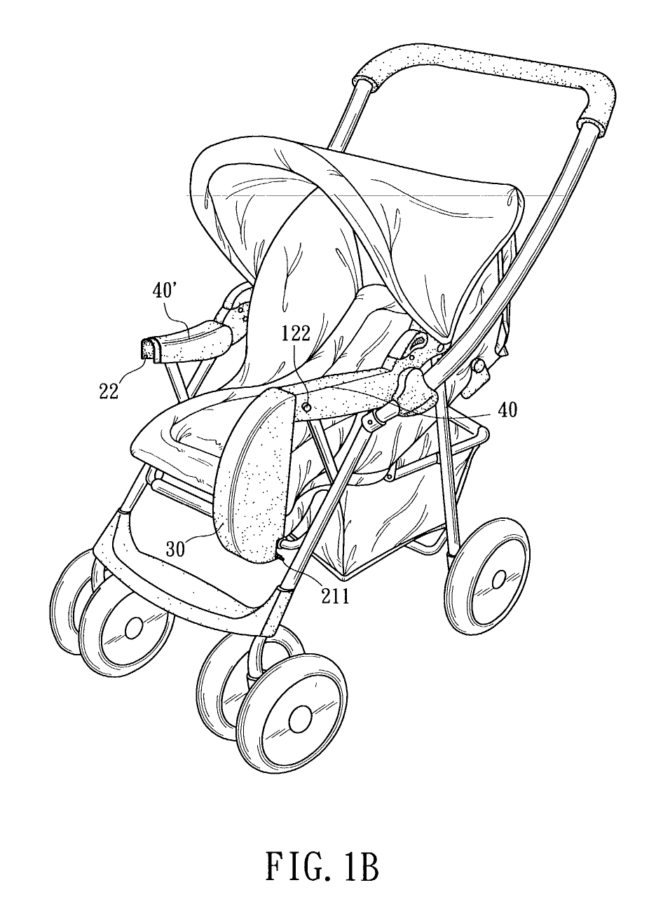

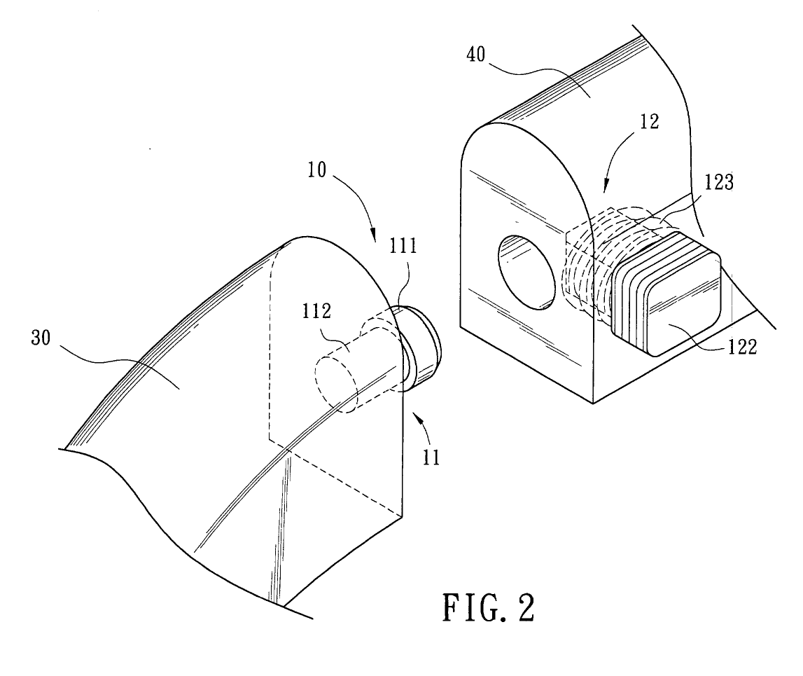

As shown in FIG. 1A, a connecting device is used to link an auxiliary member (such as a tray) 30, to a baby carrier (such as a stroller). The baby carrier includes a first side arm 40 and a second side arm 40′. The connecting device includes a pivotal mechanism 10 and a latch mechanism 20. The pivotal mechanism 10, which will be detailed shown in FIG. 2, includes a cylinder 11 mounted on the auxiliary member 30, and a recess 12 fixed on the end of first side arm 40 of the baby carrier. The recess 12 receives the cylinder 11 to make the auxiliary member 30 attach to the first side arm 40 of the baby carrier. The auxiliary member 30 attached to the end of first side arm 40 of the baby carrier selectively rotates between a usage position of horizontally placing across the baby carrier, and a storage position of vertically laying in front of the first side arm of the baby carrier (see FIG. 1B). The latch mechanism 20 locks another end of the auxiliary member 30 to the second side arm 40′ of the baby carrier, so as to fix the auxiliary member 30 in the usage position.

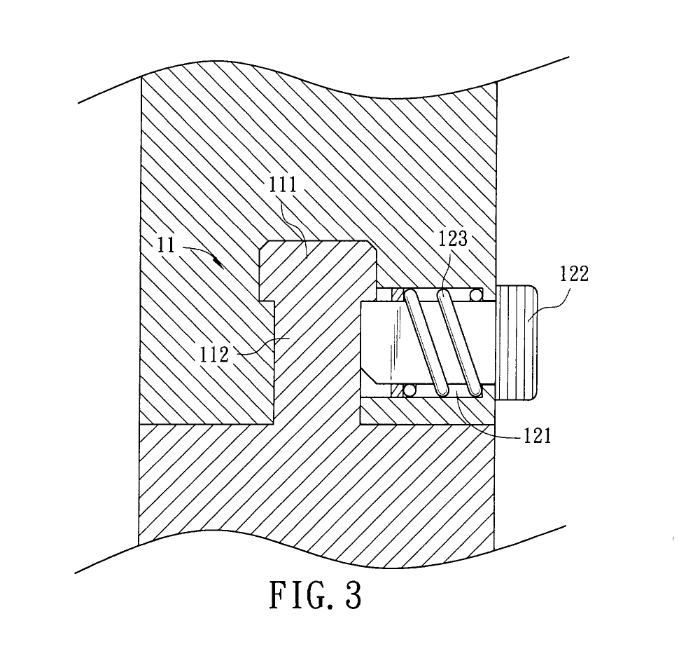

As shown in FIGS. 2 and 3, the cylinder 11 has a larger head portion 111 and an adjacent neck portion 112. The recess 12 includes a hole 121 for receiving a movable pin 122 and a retaining element 123. The cylinder 11 inserts into the recess 12 and is blocked by the pin 122. The pin 122 is pre-loaded by the retaining element 123, such as a compression spring, to be normally moved inwards the hole 121 so as to be against the neck portion 112 and block the head portion 111.

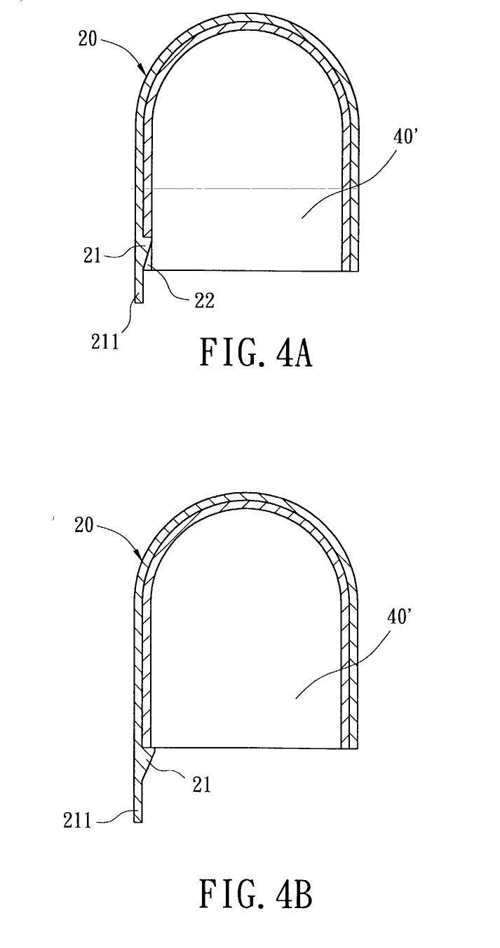

The latch mechanism for fixing the other end of the auxiliary member 30 to the second side arm 40′ of the baby carrier is illustrated in FIGS. 4A and 4B as two embodiments. In FIG. 4A, the end of the auxiliary member 30 is formed with a slot 22 to be mounted on the second side 40′. A hook 21 is formed on the auxiliary member 30 and latches into the slot 22 to fix the auxiliary member 30 on the second side arm 40′ of the baby carrier, so as to fix the auxiliary member 30 in the usage position. In order to release easily the hook 21 from the slot 22, a handler 211 is extended from the hook 21 for easy handling. In FIG. 4B, the hook 21 latches at the bottom of the second side arm 40′, so that the slot 22 as in FIG. 4A is omitted.

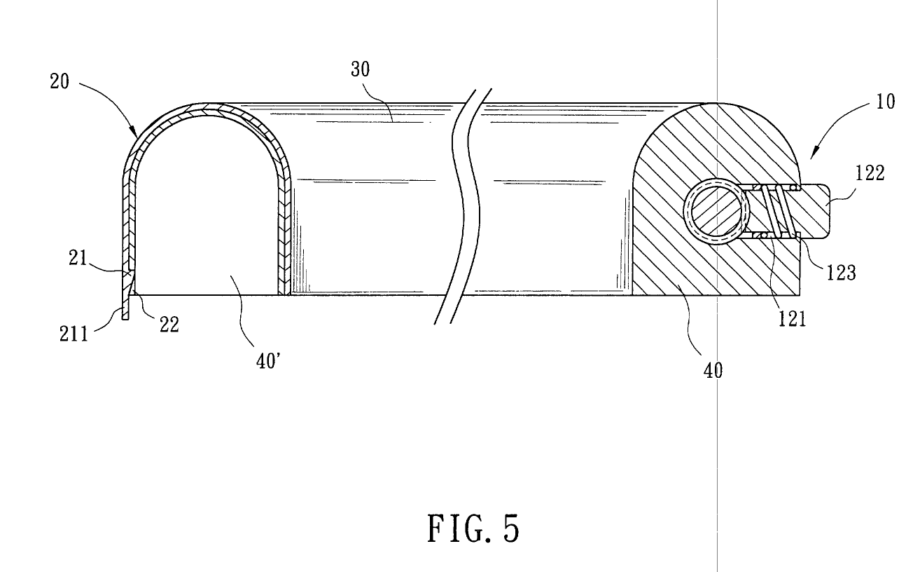

As shown in FIG. 5, the auxiliary member 30 is in the usage position. The recess 121 of the pivotal mechanism 10 receives the cylinder 11. And the pin 122 is against the neck portion 112 and blocks the head portion 111. The hook 21 latches into the slot 22 formed on the second side arm 40′, so as to fix the auxiliary member 30 in this horizontal position.

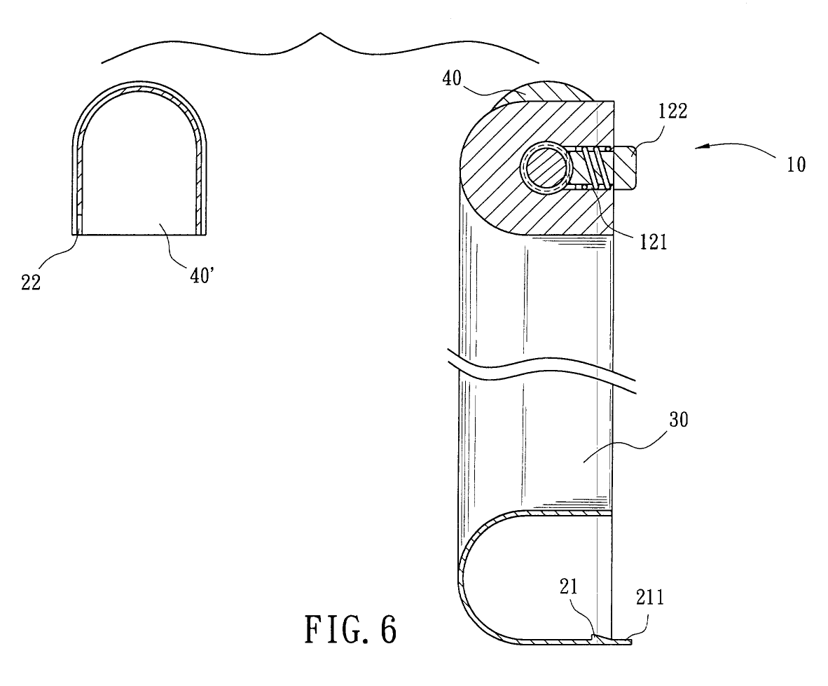

When the auxiliary member 30 is to be stored, the hook 21 is released from the slot 22 of the second side arm 40′ by pulling the handler 211. Then, the auxiliary member 30 can be rotated by the pivotal mechanism 10 to a storage position in front of the first side arm 40, as shown in FIGS. 1B, 6. And the pin 122 maintains the blocking state by the retaining element 123 to prevent the auxiliary member 30 detaching from the baby carrier during rotating. Further, pull the movable pin 122 to release the head portion 111 of the cylinder 11 so as to remove the cylinder 11 from the recess 12. And, the auxiliary member 30 is totally removed from the first side arm 40 (or the baby carrier).

To reinstall the auxiliary member 30, insert the cylinder 11 into the recess 121. There are accommodating fillets at the front end of the head portion 111 and at the inner end of the movable pin 122. So, the movable pin 122 is guided easily to pass over the head portion 111 of the cylinder 11 and finally is against the neck portion 112 and blocks the head portion 111. Then, the auxiliary member 30 is selectively moved between the storage position in front of the first side arm 40 and the usage position across the first side arm 40 and second side arm 40′.

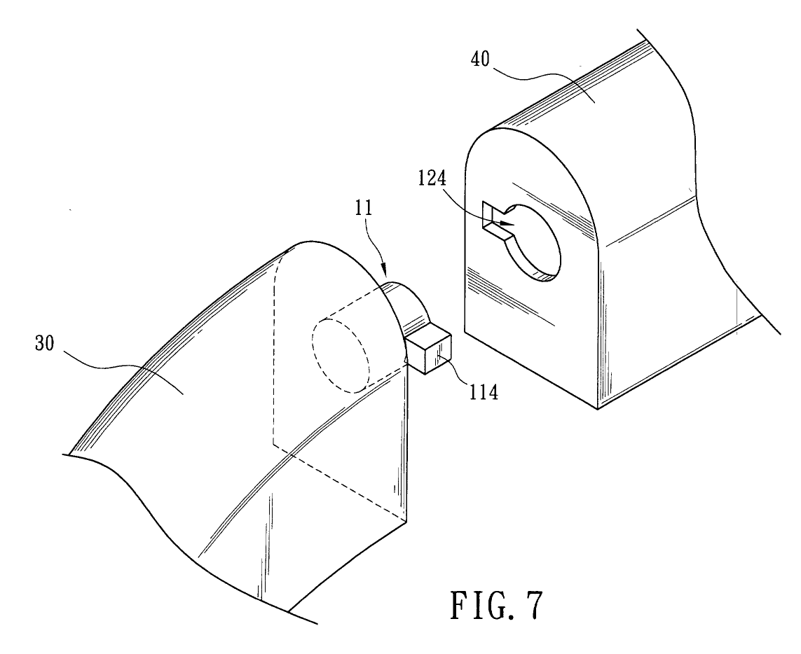

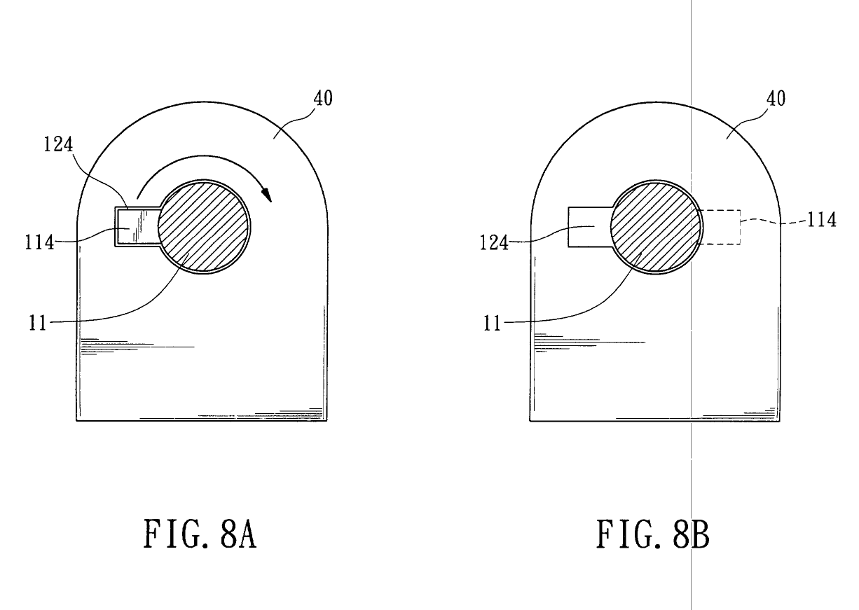

As shown in FIG. 7, the head portion 111 is a key-type portion. And the recess 12 has an accommodating opening 124 to allow the head portion 111 pass when the direction of the key 114 accommodates to the opening 124. The head portion 111 is blocked by the opening 124 excluding the key-accommodated direction. So the auxiliary member 30 rotates relative to the baby carrier without detachment (see FIG. 8B). And the head portion 111 of the auxiliary member 30 attaches or detaches when the direction of the key 114 accommodates to the opening 124 (see FIG. 8A).

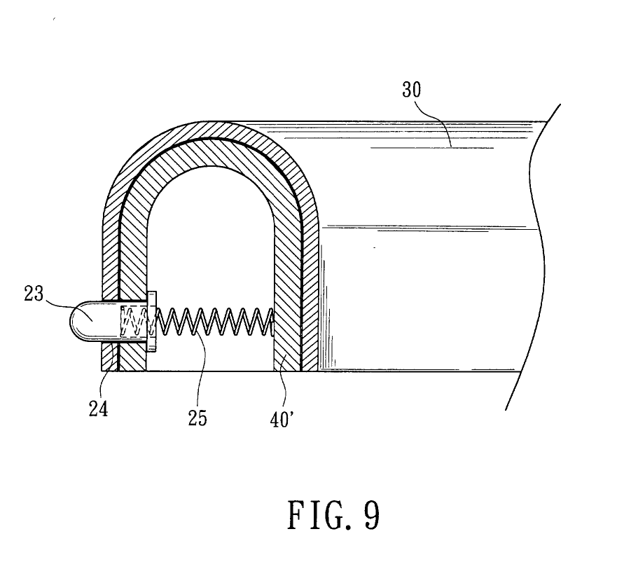

As shown in FIG. 9, the latch mechanism 20 has a pin 23 on the second side arm 40′ and a hole 24 on the auxiliary member 30. The pin 23 penetrates the hole 24 to fix the auxiliary member 30 on the second side arm 40′ of the baby carrier. And there is a retaining element 25 for retaining the pin 23 in penetrating the hole 24. By push the pin 23, the pin 23 releases the hole 24 and unlocks the auxiliary member 30. The auxiliary member 30 is totally removed from the first side arm 40 (or the baby carrier).

In conclusion, the invention provides a connecting device for linking an auxiliary member, such as a tray or a front handrail, to a baby carrier. The connecting device is capable of making the auxiliary member pivotally movable between a usage position and a storage position in front of the baby carrier. It reduces possibilities of nipping or injury to the occupant's fingers. The auxiliary member is totally removed from the baby carrier. And the cylinder or the recess can selectively set on the first side arm or the auxiliary member. The latch mechanism is the same.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A connecting device for linking an auxiliary member to the first and second side arms of a baby carrier, comprising:
a pivotal mechanism, having a cylinder mounted on one of the auxiliary member and the end of the first side arm, and a recess fixed on the other of the auxiliary member and the end of the first side arm, the recess receives the cylinder to make the auxiliary member attach to the first side arm of the baby carrier and rotate relative to the baby carrier in the longitudinal direction of the cylinder; and
a latch mechanism, for locking or unlocking the auxiliary member on the second side arm;
wherein said cylinder includes a head portion to be blocked by the recess for preventing from detachment and the auxiliary member selectively rotates between a usage position of horizontally placing across the baby carrier when locking on the second side arm by latch mechanism, and a storage position of vertically laying in front of the first side arm of the baby carrier.

2. The connecting device for linking an auxiliary member to a baby carrier as recited in claim 1 wherein the cylinder further comprises a neck portion adjacent the head portion and the recess has a pin, and the pin is against the neck portion and blocks the head portion to prevent from detaching.

3. The connecting device for linking an auxiliary member to a baby carrier as recited in claim 2 wherein the pin is movable between blocking the head portion to prevent from detaching and releasing the head portion to detach from the recess.

4. The connecting device for linking an auxiliary member to a baby carrier as recited in claim 3 wherein the pin has a retaining element for retaining said pin in blocking the head portion.

5. The connecting device for linking an auxiliary member to a baby carrier as recited in claim 3 wherein the front end of the head portion is formed with a fillet so as to push the pin outward to pass over the head portion thereof.

6. The connecting device for linking an auxiliary member to a baby carrier as recited in claim 5 wherein the inner end of the pin is formed with a fillet to accommodate the fillet of the head portion.

7. The connecting device for linking an auxiliary member to a baby carrier as recited in claim 3 wherein the recess has a hole providing the pin to move between blocking and releasing the head portion.

8. The connecting device for linking an auxiliary member to a baby carrier as recited in claim 1 wherein the latch mechanism has a hook on one of the second side arm and the auxiliary member and the hook hitches the bottom of the other of the second side arm and the auxiliary member to lock the auxiliary member on the second side arm.

9. The connecting device for linking an auxiliary member to a baby carrier as recited in claim 8 wherein the latch mechanism further comprises a handler adjacent the hook to release the hook.

10. The connecting device for linking an auxiliary member to a baby carrier as recited in claim 8 wherein the other of the second side arm and the auxiliary member has a slot for receiving the hook.

11. The connecting device for linking an auxiliary member to a baby carrier as recited in claim 1 wherein the head portion is a key-type portion and the recess has an accommodating opening to allow the head portion pass when the direction of the key accommodates to the opening.

12. The connecting device for linking an auxiliary member to a baby carrier as recited in claim 1 wherein the latch mechanism has a pin on the second side arm and a hole on the auxiliary member, and the pin penetrates the hole to fix the auxiliary member on the second side arm.

13. The connecting device for linking an auxiliary member to a baby carrier as recited in claim 12 wherein the pin has a retaining element for retaining said pin in penetrating the hole.
